(19) United States
(12) Patent Application Publication
(10) Pub. No.: US 2014/0093774 A1
(43) Pub. Date: Apr. 3, 2014

(54) LITHIUM POWDER, LITHIUM VANADIUM OXIDE, LITHIUM SECONDARY BATTERY USING A GEL-POLYMER ELECTROLYTE, AND METHOD FOR PREPARING AN ELECTRODE THEREOF

(71) Applicant: KOREA UNIVERSITY RESEARCH AND BUSINESS FOUNDATION, Seoul (KR)

(72) Inventor: Woo Young Yoon, Seoul (KR)

(21) Appl. No.: 14/118,828

(22) PCT Filed: May 18, 2012
(86) PCT No.: PCT/KR2012/003937

§ 371 Date: Nov. 19, 2013

(30) Foreign Application Priority Data
May 20, 2011 (KR) 10-2011-0047777

(51) Int. Cl. H01M 4/38; H01M 4/04; H01M 4/485

(52) U.S. Cl. CPC H01M 4/382; H01M 4/485; H01M 4/04
USPC 429/211; 429/231.95; 429/231.3; 429/224; 429/223; 429/231.1; 429/231.2; 29/623.5

(57) ABSTRACT

A lithium secondary battery includes an anode part having lithium powder, a cathode part having a non-lithiated active material and a gel-polymer electrolyte. Thus, an effective surface area of an electrode involved in a battery reaction can increase, a dendrite growth using a gel-polymer electrode can be suppressed and a high capacity and long service life can be achieved by using a non-lithiated cathode instead of a conventional lithiated cathode.

### TECHNICAL FIELD

The present invention relates to a lithium secondary battery, and more particularly, to a lithium secondary battery, which may be able to inhibit dendrite growth that is a limitation of a lithium metal electrode, by using lithium powder in an anode part, may be able to contribute safety by further inhibiting the dendrite growth and simultaneously increasing an effective surface area of an electrode participating in a battery reaction by using a gel-polymer electrolyte, and may be able to have high capacity and long lifetime by using a non-lithiated cathode instead of a typical lithiated cathode, and a method of manufacturing an electrode thereof.

### BACKGROUND ART

A lithium secondary battery is a kind of secondary batteries, in which charge and discharge are performed by intercalation and deintercalation of lithium ions in the battery. During the charge, the lithium ions move from a cathode to an anode to intercalate into a negative active material, and in contrast, during the discharge, the lithium ions intercalated into the anode move toward the cathode to intercalate into a positive active material. Since lithium secondary batteries may have high energy density and high electromotive force and may exhibit high capacity, the lithium secondary batteries have been widely used as a power source of mobile phones, notebooks, etc.

A lithium secondary battery may be generally composed of an anode, a cathode, a separator, and an electrolyte. The anode and the cathode include a negative active material and a positive active material, respectively, in which the intercalation and deintercalation of lithium ions may occur. The separator prevents a physical battery contact between the cathode and the anode. However, ions may be able to move freely through the separator. The electrolyte acts as a path through which ions are able to move freely between the cathode and the anode.

A transition metal oxide containing lithium, such as LiCoO₂ and LiMnO₂, which is lithiated cathode-based materials, are mainly used as the positive active material which is included in the cathode of the lithium secondary battery. When lithium is included in the anode, a non-lithiated oxide such as LiV₃O₈ and V₂O₅, which does not include lithium participating in a reaction, or a polymer positive active material such as a polypyrrole-LiV₃O₈ composite, may be alternatively used as the positive active material.

In contrast, a carbon-based material having excellent initial efficiency and cycle lifetime has been mainly used as the negative active material which is included in the anode of the lithium secondary battery. However, the carbon-based material may have low theoretical capacity. Lithium metal has been considered as an active material that deserves to be researched due to its high theoretical capacity (3852 mAh/g).

However, the lithium metal has not been used so far due to safety limitations according to the growth of dendrites during charge and low capacity when combined with a lithiated positive electrode. In the case that lithium is directly used as an anode, a non-lithiated cathode may be used as a component of a battery, or various measures to inhibit the growth of dendrites that are generated from the lithium have been studied in order to address the above limitations.

### DISCLOSURE OF THE INVENTION

### Technical Problem

As a result of a significant amount of research conducted into developing a lithium secondary battery, which ensures safety and has improved capacity and lifetime stability, and a preparation method thereof, the present inventors have completed the present invention.

The present invention provides a lithium secondary battery, in which lithium metal is powdered and used as a negative active material.

The present invention also provides a method of preparing the lithium secondary battery.

### Technical Solution

According to an aspect of the present invention, there is provided a lithium secondary battery including: an anode part including lithium powder; a cathode part including a non-lithiated active material; and a gel-polymer electrolyte.

A diameter of the lithium powder may be in a range of 100 nm to 40 μm.

The anode part may be porous.

The cathode part may include the non-lithiated active material adhered to an aluminum substrate which is a cathode current collector.

The cathode part may be prepared by grinding the non-lithiated active material or by graphite coating.

The non-lithiated active material may be at least one selected from the group consisting of LiCoO₂, LiMnO₂, LiNiO₂, LiCrO₂, LiMn₂O₄, and LiV₃O₈.

The non-lithiated active material may be LiV₃O₈.

According to another aspect of the present invention, there is provided a method of manufacturing a lithium secondary battery including: preparing lithium powder; preparing an anode by bonding the lithium powder; injecting a liquid gel-polymer electrolyte to uniformly permeate into the anode; and gelating the gel-polymer electrolyte, wherein the gel-polymer electrolyte may surround individual particles of the lithium powder while gelating the gel-polymer electrolyte.

### Advantageous Effects

A lithium secondary battery according to embodiments of the present invention may inhibit dendrite growth and may increase the capacity and lifetime stability of a battery by using an anode structure formed of lithium powder that is prepared for preventing the dendrite growth, a gel-polymer electrolyte for ensuring safety, and LiV₃O₈ as a non-lithiated cathode used for increasing the capacity and lifetime stability. The gel-polymer electrolyte, in the state of being injected, may induce lithium powder, which is in the electrode as well as on the surface of the electrode, to participate in a battery reaction by deeply permeating into the lithium powder electrode including pores, and may inhibit the growth of dendrites by tightly surrounding the powder after gelation. Accordingly, limitations related to the safety and lifetime stability of a lithium metal electrode, which has been a typical issue, may be addressed.

### BRIEF DESCRIPTION OF THE DRAWINGS

FIG. 1 illustrates an embodiment of a configuration of a lithium secondary battery according to an embodiment of the present invention;

FIG. 2 is SEM images of a lithium powder electrode coated with a gel-polymer electrolyte in FIG. 1, which illustrate (a) a cross section, (b) a side, (c) a shape of powder after 10 times of charge, (d) a shape of powder after 10 times of discharge, respectively;

FIG. 3 illustrates the results of charge and discharge characteristics of lithium (Li)-powder/gel-polymer electrolyte (GPE)/lithium vanadium oxide (LVO), which demonstrate that a secondary battery may be prepared by using the above configuration. FIG. 3 illustrates that a current density (C-rate) is 0.1 and 30 times or more of cycles continues. After cycles, the battery maintains about 69% (130 mAh/g) of capacity based on an initial capacity (189 mAh/g); and

FIG. 4 illustrates cycle characteristics of a LVO electrode battery having a Li-foil counter electrode and a LVO-C (sample which is subject to the refinement and carbon coating of LVO by grinding the LVO with graphite) electrode battery. The present results were obtained by targeting to investigate the effect of improving electrical conductivity by simple grinding of LVO when the Li-foil is used as an anode and a typical liquid electrolyte is used as an electrolyte. After 50 charge and discharge cycles, the LVO electrode battery exhibits 76% of capacity based on an initial capacity, but the LVO-C electrode battery exhibits 90% of capacity based on the initial capacity. Therefore, according to the results of FIG. 3, capacity according to cycles may be significantly improved when the LVO-C is used instead of the LVO.

### MODE FOR CARRYING OUT THE INVENTION

The present invention relates to a method of increasing safety, capacity, and lifetime stability of a secondary battery by constituting the battery using lithium metal powder as an anode material (active material), a gel-polymer electrolyte (GPE), and lithium vanadium oxide (LiV₃O₈), a non-lithiated material, as a positive active material, and a lithium secondary battery using the method.

In the present invention, lithium powder, which is prepared by using a method of dissolving and stirring bulk lithium in a silicon oil, is directly used as an anode material, and the anode material and LiV₃O₈ as a non-lithiated cathode material are used to constitute a battery. Thus, the capacity and lifetime of the battery are increased. Also, a gel-polymer is used as an electrolyte in order to prevent the risks of using lithium metal.

The lithium secondary battery according to the present invention includes an anode part prepared using lithium metal powder, a cathode part including a non-lithiated positive active material that may intercalate lithium ions, a separator separating the anode part and the cathode part, and a case that includes a gel-polymer as an electrolyte and accommodates the anode part, the cathode part, and the separator.

According to an embodiment of the present invention, provided is a lithium secondary battery that includes an anode part including lithium powder, a cathode part including a non-lithiated active material, and a gel-polymer electrolyte.

According to an embodiment of the present invention, a diameter of the lithium powder may be in a range of 100 nm to 40 μm.

The present invention is characterized in that a liquid polymer electrolyte (gel-polymer electrolyte) having high stability but relatively low ionic conductivity may maximize an effective area, in which a porous lithium powder anode may be reacted, and may inhibit the growth of lithium dendrites by the gelation of the liquid polymer electrolyte around the lithium electrode. In this case, when the diameter of the lithium powder is less than 100 nm, adhesiveness of the lithium powder with respect to an anode plate may decrease so that the gel-polymer electrolyte may not sufficiently permeate into the powder. Thus, the effective area required for the reaction may decrease. When the diameter of the lithium powder is greater than 40 μm, the effective area required for the reaction may not be sufficiently secured.

According to an embodiment of the present invention, the cathode part may include the non-lithiated active material adhered to an aluminum substrate which is a cathode current collector.

According to an embodiment of the present invention, the cathode part may be prepared by grinding the non-lithiated active material or by graphite coating. In this case, the grinding or the graphite coating may be performed by using a typical method known in the art and is not particularly limited.

According to an embodiment of the present invention, cycle characteristics of the cathode part may be improved by coating the non-lithiated active material with carbon or diamond like carbon (DLC).

According to an embodiment of the present invention, the non-lithiated active material may be one or more selected from the group consisting of LiCoO₂, LiMnO₂, LiNiO₂, LiCrO₂, LiMn₂O₄, and LiV₃O₈.

According to an embodiment of the present invention, the non-lithiated active material may be LiV₃O₈.

According to another aspect of the present invention, provided is a method of preparing a lithium secondary battery including preparing lithium powder; preparing a porous anode by bonding the lithium powder; injecting a liquid gel-polymer electrolyte to uniformly permeate into the anode; and gelating the gel-polymer electrolyte.

In this case, the polymer electrolyte may surround individual particles of the lithium powder during the gelating of the gel-polymer electrolyte.

According to an embodiment of the present invention, a lithium secondary battery including an anode part formed by using lithium powder; a cathode part including a positive active material that may intercalate and deintercalate lithium ions; a separator separating the anode part and the cathode part; and a case that stores an electrolyte solution able to transfer lithium ions and accommodates the anode part, the cathode part, and the separator.

Hereinafter, a lithium secondary battery using a gel-polymer electrolyte according to an exemplary embodiment of the present invention and a method of preparing an electrode thereof will be described in detail below with reference to the accompanying drawings.

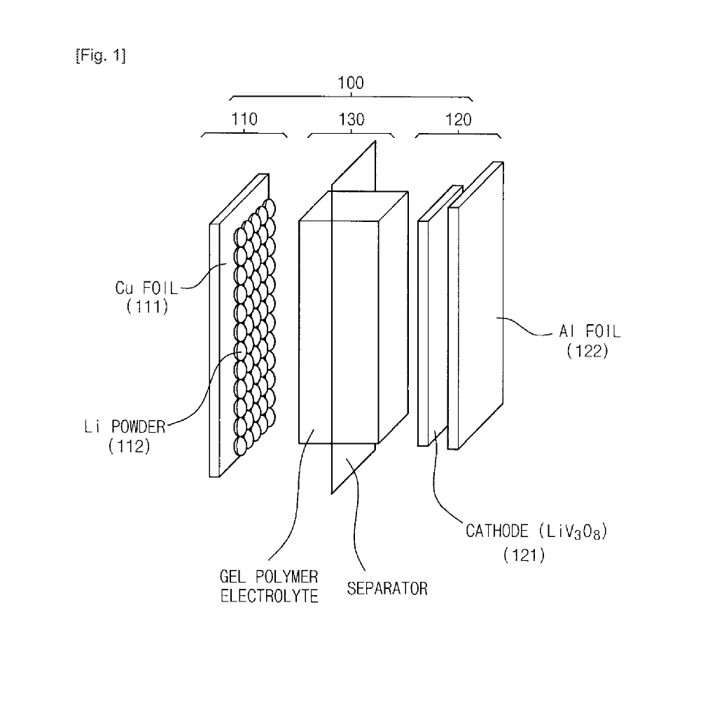

FIG. 1 illustrates an embodiment of a configuration of a lithium secondary battery 100 according to an embodiment of the present invention.

Referring to FIG. 1, the illustrated lithium secondary battery 100 includes an anode part 110, a cathode part 120, and a separator 130.

The anode part 110 includes a negative active material that may intercalate and deintercalate lithium ions. Lithium powder, which is obtained by dissolving and stirring lithium metal having a theoretical capacity of 3862 mAh/g in a silicon oil, is used as the negative active material.

With respect to a secondary battery using lithium metal as an anode material, the lifetime and safety of the battery may be limited due to the growth of dendrites formed from lithium during charge. However, in the present invention, the growth of dendrites may be inhibited by using a lithium powder electrode instead of a Li-foil electrode.

Referring again to FIG. 1, the anode part 110 includes a current collector 111 and lithium powder 112.

A thin metal foil is used as the current collector 111. The current collector 111 acts to electrically connect an anode to a negative terminal (not shown) of the battery. According to an embodiment of the present invention, a copper foil is used as the current collector 111.

The cathode part 120 includes a positive active material that may intercalate and deintercalate lithium ions. The positive active material may include transition metal oxide including lithium (lithiated cathode-based material) used in a battery reaction, such as LiCoO₂, LiMnO₂, LiNiO₂, LiCrO₂, and LiMn₂O₄. Also, the positive active material included in the cathode part 120 may be lithium iron phosphate (LiFePO₄) which is advantageous in that LiFePO₄ is eco-friendly, the price of a raw material is relatively inexpensive because LiFePO₄ contains iron, an abundant reserve, instead of using rare metal such as cobalt (Co), and LiFePO₄ may significantly contribute to battery capacity.

When the above lithiated oxides are used as the cathode, a material not including lithium, such as carbon (C), silicon (Si), and SiO, is used as the anode. However, if lithium metal is used in the anode when the lithiated cathode is used, performance, such as capacity and lifetime stability, of the battery may degrade in comparison to the case of using a non-lithiated cathode.

Since the lithium powder is used as the anode in the embodiment of the present invention, a non-lithiated cathode-based LiV₃O₈, which does not include lithium participating in a battery reaction, is used as the positive active material of the cathode. In addition, an oxide, such as V₂O₅, may be used as the positive active material of the cathode. In particular, in the present invention, lithium vanadium oxide (LVO), in which performance thereof is significantly improved by grinding the LVO with graphite, may be used in order to improve the degradation of cycle characteristics due to the low electrical conductivity of the LVO.

According to an embodiment of the present invention, cycle characteristics may be improved by coating the non-lithiated cathode-based positive active material with carbon or DLC.

The separator 130 separates the anode part 110 and the cathode part 120, wherein the separator 120 may prevent a physical electrode contact between the cathode and the anode, and the separator 130 in the form of a porous membrane may allow ions to be free to move therethrough.

The separator 130 may be a single or multiple layer, which is formed of a material, such as polyolefin, polypropylene, and polyethylene. Also, a microporous film and a nonwoven fabric may be used.

In addition, the lithium secondary battery may include an electrolyte (not shown) able to transfer lithium ions and a case (not shown) storing the electrolyte.

The electrolyte may include a non-aqueous organic solvent, in which a lithium salt may be included. A mixture of at least one of cyclic or acyclic carbonate and aliphatic carboxylic acid ester may be used as the non-aqueous organic solvent.

In the present invention, a gel-polymer is used as the electrolyte in order to inhibit the dendrite growth in the lithium metal electrode and improve stability.

The case, in which the electrolyte is stored, accommodates the anode part 110, the cathode part 120, and the separator 130.

FIG. 1 schematically illustrates an example of the preparation of a lithium secondary battery, in which lithium powder is used as an anode material and LiV₃O₈ is used as a cathode material in a gel-polymer electrolyte.

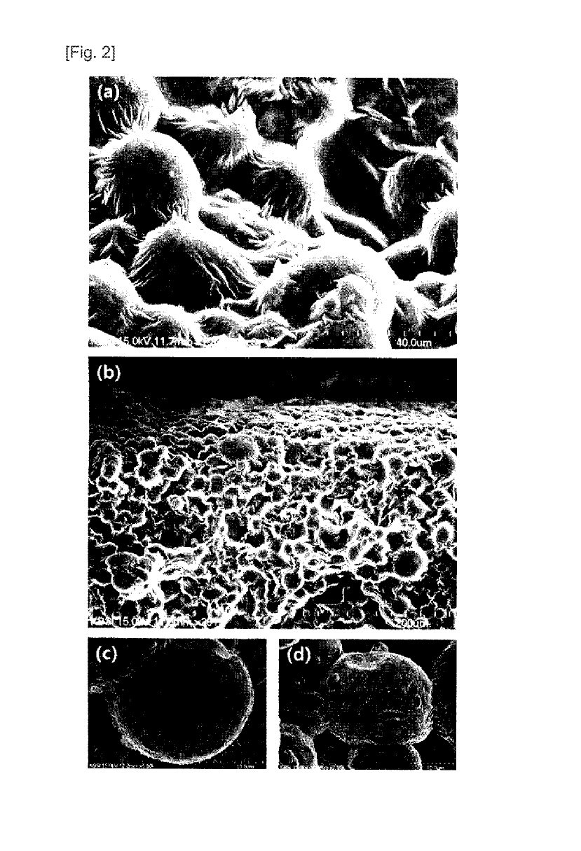

FIG. 2 is SEM images of lithium powder coated with a gel-polymer electrolyte of the anode part in FIG. 1. It may be understood that the electrolyte surrounds the powder by permeating into an inner layer as well as the surface of the lithium powder electrode. The gel-polymer electrolyte is a liquid during the injection so that the electrolyte permeates into the porous lithium powder electrode. Therefore, when the battery is operated after gelation, lithium powders in the electrode as well as on the surface thereof may participate in the battery reaction. The gelated electrolyte may inhibit the dendrite growth that may occur in the powder during charge by surrounding individual particles of the lithium powder. That is, the liquid polymer electrolyte (gel-polymer electrolyte) may complement disadvantages of two active materials in such a manner that the liquid polymer electrolyte is combined with the porous lithium powder anode so that low ionic conductivity of the electrolyte may be improved by increasing the effective area participating in the reaction of the powder electrode, and the lithium electrode may inhibit the dendrite growth of lithium by the gelation of the liquid polymer electrolyte.

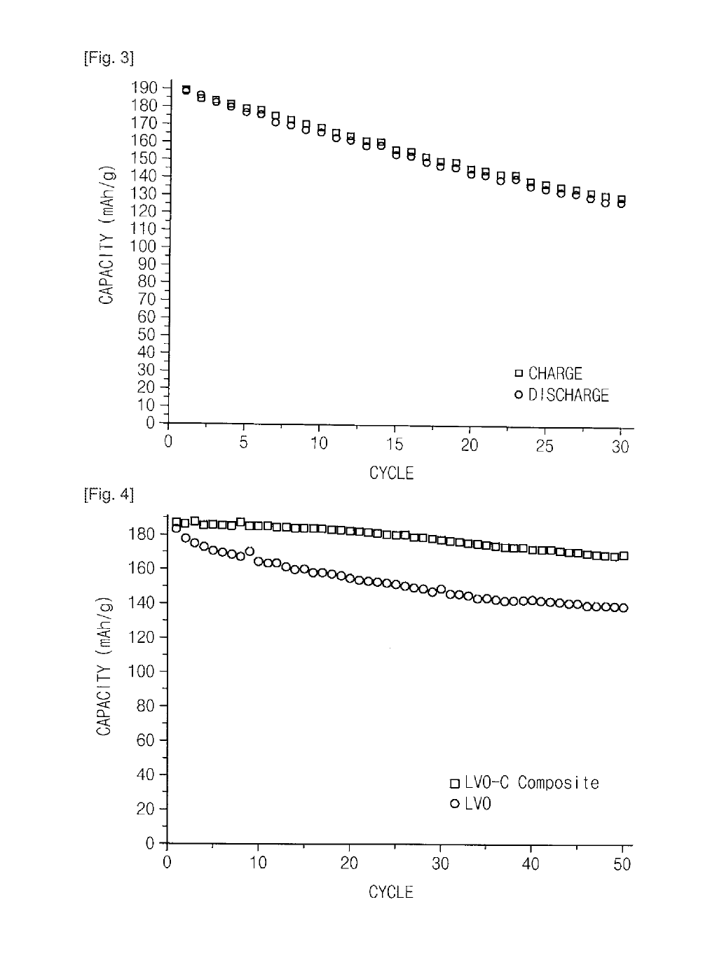

FIG. 3 illustrates the results of charge and discharge characteristics of lithium-ion battery (Li powder/GPE/LVO) illustrated in FIG. 1. Referring to FIG. 3, a secondary battery having long-life characteristics may be prepared by using the configuration of the battery suggested in the present invention. As illustrated in FIG. 3, the battery may operate for 30 cycles or more, and it may be understood that the battery maintains about 69% (130 mAh/g) of capacity based on an initial capacity (189 mAh/g) after 30 charge and discharge cycles.

FIG. 4 compares characteristics of a LVO cathode battery, and a battery including a cathode that is prepared by grinding LVO with graphite. It may be understood that electrical conductivity of the LVO may be increased by grinding the LVO with graphite (C) and this results in the improvement of the cycle characteristics of the battery. Furthermore, one of key features of the present invention is that the LVO material is used as a cathode material by refining the LVO material and improving the electrical conductivity thereof.

### INDUSTRIAL APPLICABILITY

A lithium secondary battery according to embodiments of the present invention may inhibit dendrite growth and may increase the capacity and lifetime stability of a battery by using an anode structure formed of lithium powder that is prepared for preventing the dendrite growth, a gel-polymer electrolyte for ensuring safety, and LiV₃O₈ as a non-lithiated cathode used for increasing the capacity and lifetime stability. The gel-polymer electrolyte, in the state of being injected, may induce lithium powder, which is in the electrode as well as on the surface of the electrode, to participate in a battery reaction by deeply permeating into the lithium powder electrode including pores, and may inhibit the growth of dendrites by tightly surrounding the powder after gelation. Accordingly, limitations related to the safety and lifetime stability of a lithium metal electrode, which has been a typical issue, may be addressed.

While the invention has been particularly shown and described with reference to exemplary embodiments thereof, it will be understood by those of ordinary skill in the art that various changes in form and details may be made therein without departing from the spirit and scope of the invention as defined by the following claims. Therefore, the scope of the invention is defined not by the detailed description of the invention but by the appended claims.

1. A lithium secondary battery comprising:
an anode part including lithium powder; a cathode part including a non-lithiated active material; and a gel-polymer electrolyte (GPE).

2. The lithium secondary battery of claim 1, wherein a diameter of the lithium powder is in a range of 100 nm to 40 μm.

3. The lithium secondary battery of claim 1, wherein the cathode part comprises the non-lithiated active material adhered to an aluminum substrate which is a cathode current collector.

4. The lithium secondary battery of claim 1, wherein the cathode part is prepared by grinding the non-lithiated active material or by graphite coating.

5. The lithium secondary battery of claim 4, wherein the non-lithiated active material is at least one selected from the group consisting of LiCoO₂, LiMnO₂, LiNiO₂, LiCrO₂, LiMn₂O₄, and LiV₃O₈.

6. The lithium secondary battery of claim 5, wherein the non-lithiated active material is LiV₃O₈.

7. A method of manufacturing a lithium secondary battery, the method comprising:
preparing lithium powder;
preparing an anode by bonding the lithium powder;
injecting a liquid gel-polymer electrolyte to uniformly permeate into the anode; and
gelating the gel-polymer electrolyte,
wherein the gel-polymer electrolyte surrounds individual particles of the lithium powder while gelating the gel-polymer electrolyte.
